(19) United States
(12) Patent Application Publication
(10) Pub. No.: US 2014/0244361 A1
(43) Pub. Date: Aug. 28, 2014

(54) SYSTEM AND METHOD OF PREDICTING PURCHASE BEHAVIORS FROM SOCIAL MEDIA

(71) Applicants: Yongzheng Zhang, San Jose, CA (US); Marco Pennacchiotti, Mountian View, CA (US)

(72) Inventors: Yongzheng Zhang, San Jose, CA (US); Marco Pennacchiotti, Mountian View, CA (US)

(73) Assignee: EBAY INC., SAN JOSE, CA (US)

(21) Appl. No.: 14/103,062

(22) Filed: Dec. 11, 2013

Related U.S. Application Data
(60) Provisional application No. 61/768,965, filed on Feb. 25, 2013.

(51) Int. Cl. G06Q 30/02

(52) U.S. Cl. CPC G06Q 30/0204
USPC 705/7.33

(57) ABSTRACT

In an example embodiment, a first social media profile is retrieved. Express interests in the first social media profile are extracted, and social media categories corresponding to the express interests are identified. Demographic information is also extracted from the first social media profile. Then, the identified social media categories and demographic information are correlated with ecommerce categories of purchases. Using results from the correlating, a machine learning process is configured, the machine learning process accepting a second social media profile as input and returning a prediction of an ecommerce category as output.

### PRIORITY

This application is a Non-Provisional of and claims the benefit of priority under 35 U.S.C. §119(e) from U.S. Provisional Application Ser. No. 61/768,965, entitled “SYSTEM AND METHOD OF PREDICTING PURCHASE BEHAVIORS FROM SOCIAL MEDIA,” filed on Feb. 25, 2013 which is hereby incorporated by reference herein in its entirety.

### TECHNICAL FIELD

This application relates generally to ecommerce websites. More specifically, the application relates to a system and method of predicting purchase behaviors from social media

### BACKGROUND

In the last few years, many ecommerce companies have been moving into the social media space by allowing users to sign in using one or multiple social media accounts (e.g., Facebook™, Twitter™, LinkedIn™). The main strategic goal for integrating social media is to provide users with a more engaging and social experience, thus increasing user retention and adoptions.

However, ecommerce companies have not fully developed technologies to leverage social media information to improve important features such as purchase behavior prediction and product recommendation. Social media information could also help solve the cold start problem, i.e. providing an engaging and personalized experience to brand new users. When a user is new, traditional prediction and recommendation algorithms cannot in fact be applied, as no past information about the user is available.

### BRIEF DESCRIPTION OF DRAWINGS

FIG. 1 is a network diagram depicting a client-server system, within which one example embodiment may be deployed.

FIG. 2 is a block diagram illustrating marketplace and payment applications that, in one example embodiment, are provided as part of the networked system.

FIG. 3 is an example block diagram illustrating multiple components that, in one example embodiment, are provided within the publication system of the network-based publisher.

FIG. 4 is a block diagram illustrating a social data mining engine, according to some embodiments.

FIG. 5 is a block diagram illustrating social applications that execute on a social networking server, such as one located on a third-party platform, according to an example embodiment.

FIG. 6 is a block diagram illustrating a database, according to an example embodiment, at the social networking server.

FIG. 7 reports a pie graph showing the distribution of gender and age in the dataset in accordance with an example embodiment.

FIG. 8 reports a graph showing the distribution of social media likes for users in accordance with an example embodiment.

FIG. 9 reports a graph showing the distribution of likes for social media pages in accordance with an example embodiment.

FIG. 10 reports a graph showing the number of purchases relative to the number of users in accordance with an example embodiment.

FIG. 11 reports a graph showing the distribution of purchases by ecommerce category (also known as meta-category), in accordance with an example embodiment.

FIG. 12 depicts a graph showing a probability distribution by k-ranking in accordance with an example embodiment.

FIG. 13 depicts a graph showing the percentage of ecommerce categories that have a given number of highly correlated social media categories in accordance with an example embodiment.

FIG. 14 is a graph depicting the trend of Normalized Discounted Cumulative Gain (NDCG) at different rank levels, for all the experimented algorithms, in accordance with an example embodiment.

FIG. 15 is a flow diagram illustrating a method in accordance with an example embodiment.

FIG. 16 is a block diagram illustrating a mobile device, according to an example embodiment.

FIG. 17 is a block diagram of machine in the example form of a computer system within which instructions may be executed for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

In an example embodiment, a system and method are provided to predict purchase behaviors of social media users that have unknown history on an ecommerce website (i.e., cold start). More particularly, in an example embodiment, the aim is to predict which product categories (e.g., electronics, clothing) the user will buy from by using information derived solely from the social network. Such a predictive system would help in several practical scenarios, including:

(1) building a cold start recommender system, by providing high-level recommendations to social media users that connect for the first time to an ecommerce website;
(2) improving existing product recommendation engines, by providing category-level priors that can guide the recommender system to find domains of interest for the user; and
(3) providing ecommerce companies with tools for targeted social media campaigns

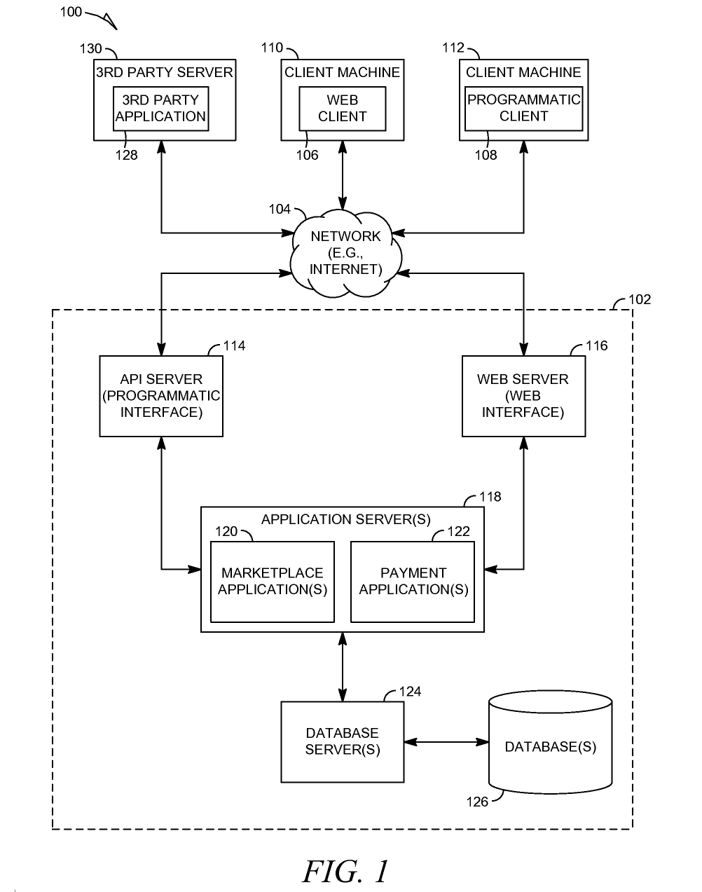

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

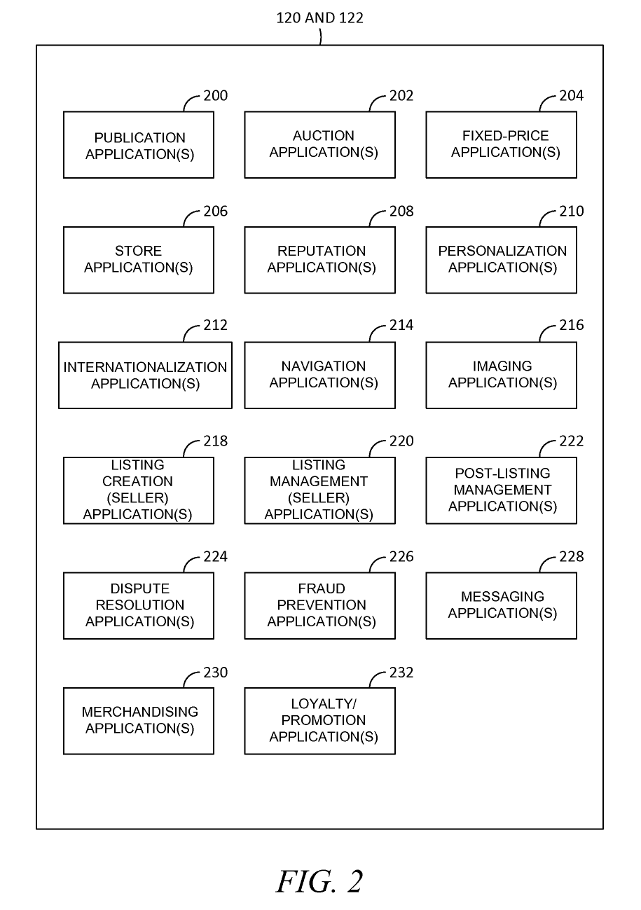

FIG. 2 is a block diagram illustrating marketplace and payment applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or providing promotional and merchandising information to users)). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

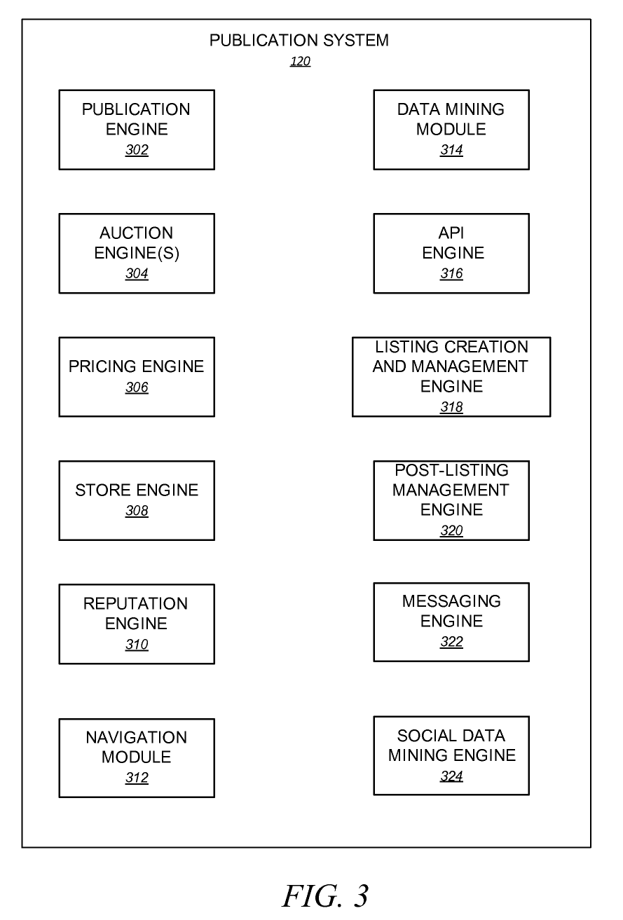

Referring now to FIG. 3, an example block diagram illustrating multiple components that, in one example embodiment, are provided within the publication system 120 of the networked system 102 (see FIG. 1), is shown. The publication system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more database(s) 126 via the one or more database servers 124, both shown in FIG. 1.

In one embodiment, the publication system 120 provides a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication system 120 may comprise at least one publication engine 302 and one or more auction engines 304 that support auction-format listing and price setting mechanisms (e.g., English, Dutch, Chinese, Double, reverse auctions, etc.). The various auction engines 304 also provide a number of features in support of these auction-format listings, such as a reserve price feature whereby a seller may specify a reserve price in connection with a listing, and a proxy-bidding feature whereby a bidder may invoke automated proxy bidding.

A pricing engine 306 supports various price listing formats. One such format is a fixed-price listing format (e.g., the traditional classified advertisement-type listing or a catalog listing). Another format comprises a buyout-type listing. Buyout-type listings (e.g., the Buy-It-Now (BIN) technology developed by eBay™ Inc., of San Jose, Calif.) may be offered in conjunction with auction-format listings and may allow a buyer to purchase goods or services, which are also being offered for sale via an auction, for a fixed price that is typically higher than a starting price of an auction for an item.

A store engine 308 allows a seller to group listings within a “virtual” store, which may be branded and otherwise personalized by and for the seller. Such a virtual store may also offer promotions, incentives, and features that are specific and personalized to the seller. In one example, the seller may offer a plurality of items as Buy-It-Now items in the virtual store, offer a plurality of items for auction, or a combination of both.

A reputation engine 310 allows users that transact, utilizing the networked system 102, to establish, build, and maintain reputations. These reputations may be made available and published to potential trading partners. Because the publication system 120 supports person-to-person trading between unknown entities, users may otherwise have no history or other reference information whereby the trustworthiness and credibility of potential trading partners may be assessed. The reputation engine 310 allows a user, for example through feedback provided by one or more other transaction partners, to establish a reputation within the network-based publication system over time. Other potential trading partners may then reference the reputation for purposes of assessing credibility and trustworthiness.

Navigation of the networked system 102 may be facilitated by a navigation module 312. For example, a search engine (not shown) of the navigation module 312 enables keyword searches of listings published via the publication system 120. In a further example, a browse engine (not shown) of the navigation module 312 allows users to browse various category, catalog, or inventory data structures according to which listings may be classified within the publication system 120. The search engine and the browse engine may provide retrieved search results or browsed listings to a client device. Various other navigation applications within the navigation module 312 may be provided to supplement the searching and browsing applications.

In order to make listings available via the networked system 102 as visually informing and attractive as possible, the publication system 120 may include a data mining module 314 that enables users to upload images for inclusion within listings and to incorporate images within viewed listings. The social data mining engine module 314 also receives social data from a user and utilizes the social data to identify an item depicted or described by the social data.

An API engine 316 stores API information for various third-party platforms and interfaces. For example, the API engine 316 may store API calls used to interface with a third-party platform. In the event a publication application(s) 120 is to contact a third-party application or platform, the API engine 316 may provide the appropriate API call to use to initiate contact. In some embodiments, the API engine 316 may receive parameters to be used for a call to a third-party application or platform and may generate the proper API call to initiate the contact.

A listing creation and management engine 318 (which could be a separate creation engine and a separate management engine) allows sellers to create and manage listings. Specifically, where a particular seller has authored or published a large number of listings, the management of such listings may present a challenge. The listing creation and management engine 318 provides a number of features (e.g., auto-relisting, inventory level monitors, etc.) to assist the seller in managing such listings.

A post-listing management engine 320 also assists sellers with a number of activities that typically occur post-listing. For example, upon completion of an auction facilitated by the one or more auction engines 304, a seller may wish to leave feedback regarding a particular buyer. To this end, the post-listing management engine 320 provides an interface to the reputation engine 310 allowing the seller to conveniently provide feedback regarding multiple buyers to the reputation engine 310.

A messaging engine 322 is responsible for the generation and delivery of messages to users of the networked system 102. Such messages include, for example, advising users regarding the status of listings and best offers (e.g., providing an acceptance notice to a buyer who made a best offer to a seller). The messaging engine 322 may utilize any one of a number of message delivery networks and platforms to deliver messages to users. For example, the messaging engine 322 may deliver electronic mail (e-mail), an instant message (IM), a Short Message Service (SMS), text, facsimile, or voice (e.g., Voice over IP (VoIP)) messages via wired networks (e.g., the Internet), a Plain Old Telephone Service (POTS) network, or wireless networks (e.g., mobile, cellular, WiFi, WiMAX).

A social data mining engine 324 analyzes the data gathered by the networked system 102 from interactions between the client machines 110, 112 and the networked system 102. In some embodiments, the social data mining engine 324 also analyzes the data gathered by the networked system 102 from interactions between components of the networked system 102 and/or client machines 110, 112 and third-party platforms, such as social networks like Twitter™, and also publications, such as eBay™ and Amazon. The social data mining engine 324 uses the data to identify certain trends or patterns in the data. For example, the social data mining engine 324 may identify patterns, which may help to improve search query processing, user profiling, and identification of relevant search results, among other things.

A taxonomy engine (not pictured) uses the patterns and trends identified by the social data mining engine 324 to obtain a variety of data, including products, item listings, search queries, keywords, search results, and individual attributes of items, users, or products, among other things, and revise the publication system taxonomy as discussed below. In some embodiments, the taxonomy engine may assign a score to each piece of data based on the frequency of occurrence of the piece of data in the mined set of data. In some embodiments, the taxonomy engine may assign or adjust a score of a piece of data pertaining to an item (e.g., one or more keywords with logic, a product listing, an individual attribute of the item) based on input data received from users. The score may represent a relevance of the piece of data to the item or an aspect of the item. In some embodiments, the taxonomy engine may compare data received from the third party platform to previously received and stored data from the third party platform. Alternatively, the taxonomy engine may compare data received from the third party platform with data in the publication system's own taxonomy.

Although the various components of the publication system 120 have been defined in terms of a variety of individual modules, a skilled artisan will recognize that many of the items can be combined or organized in other ways. Furthermore, not all components of the publication system 120 have been included in FIG. 3. In general, components, protocols, structures, and techniques not directly related to functions of example embodiments (e.g., dispute resolution engine, loyalty promotion engine, personalization engines, etc.) have not been shown or discussed in detail. The description given herein simply provides a variety of example embodiments to aid the reader in an understanding of the systems and methods used herein.

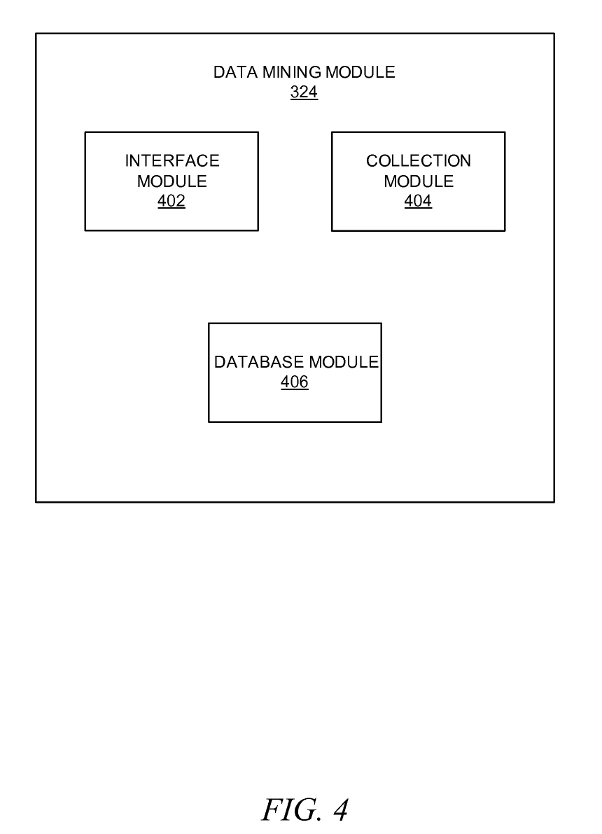

FIG. 4 is a block diagram illustrating the social data mining engine 324, according to some embodiments. Information may be mined from social media websites and communications, such as from Facebook™ and Twitter™ feeds.

Referring to FIG. 4, an interface module 402 may store components used to interface with a third party platform from which data is mined. The third party platform could be from eBay™ and/or Amazon, or from a social network such as Twitter™. Interfacing with third party platforms may entail providing data related to items about which searches or opinions from users of the third party platform are solicited. The user input may include search keywords, descriptions, opinions, or other text, along with non-textual input, such as clicks, highlighting, and other interactions with the provided item text and visual data.

A collection module 404 collects the data mined from the third party platform. For mining Twitter™, tweets and retweets of a particular search may be included. In some embodiments the publication system may also store Twitter™ IDs, their bio, location, how many followers, their following, and similar information that may be publically available from the social network. In some embodiments, the collection module 404 interfaces with the third party platform directly and collects data entered by the user. In some embodiments, the collection module 404 collects the data from the interface module 402.

A database module 406 interfaces with one or more databases such as database 126 of FIG. 1 to store the data collected by the collection module 404. The database module 406 also interfaces with the one or more databases to retrieve data related to the items presented in the third party platform. For example, the database module 406 may retrieve searches related to a certain product, and provide the searches to the third party platform for purposes of comparing a user's search to previously stored searches. Based on the comparison, the interface module 402 or the taxonomy engine may revise the publication system's taxonomy.

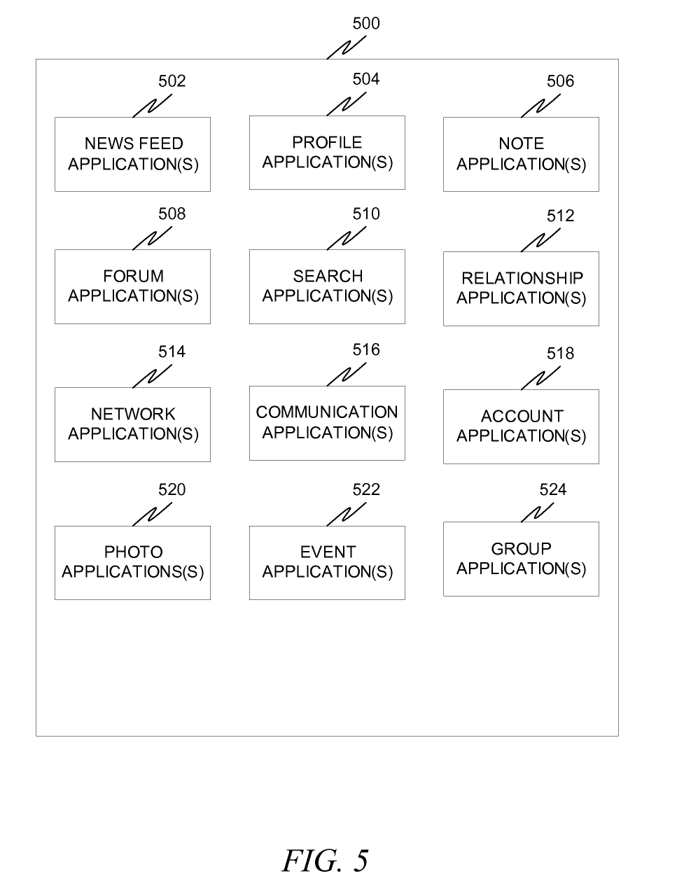

FIG. 5 is a block diagram illustrating social applications 500 that execute on a social networking server, such as one located on third-party server 130 of FIG. 1, according to an example embodiment. The social applications 500 include news feed applications 502, profile applications 504, note applications 506, forum applications 508, search applications 510, relationship applications 512, network applications 514, communication applications 516, account applications 518, photo applications 520, event applications 522, and group applications 524.

The news feed applications 502 publish events associated with the user and friends of the user on the social networking server. The news feed applications 502 may publish the events on the user profile of a user. For example, the news feed applications 502 may publish the uploading of a photo album by one user on the user profile of the user and the user profiles of friends of the user.

The profile applications 504 may maintain user profiles for each of the users on the social networking server. Further, the profile applications 504 may enable a user to restrict access to selected parts of their profile to prevent viewing by other users. The note applications 506 may be used to author notes that may be published on various user interfaces.

The forum applications 508 may maintain a forum in which users may post comments and display the forum via the profile associated with a user. The user may add comments to the forum, remove comments from the forum, and restrict visibility to other users. In addition, other users may post comments to the forum.

The search applications 510 may enable a user to perform a keyword search for users, groups, and events. In addition, the search applications 510 may enable a user to search for content (e.g., favorite movies) on profiles accessible to the user.

The relationship applications 512 may maintain relationship information for the users. The network applications 514 may facilitate the addition of social networks by a user, with the social networks based on a school, workplace, or region, or any social construct for which the user may prove an affiliation. The communication applications 516 may process incoming and outgoing messages, maintain an inbox for each user, facilitate sharing of content, facilitate interaction among friends (e.g., poking), process requests, process events, process group invitations, and process communicating notifications.

The account applications 518 may provide services to facilitate registering, updating, and deleting user accounts. The photo applications 520 may provide services to upload photographs, arrange photographs, set privacy options for albums, and tag photographs with text strings. The event applications 522 may provide services to create events, review upcoming events, and review past events. The group applications 524 may be used to maintain group information, display group information, and navigate to groups.

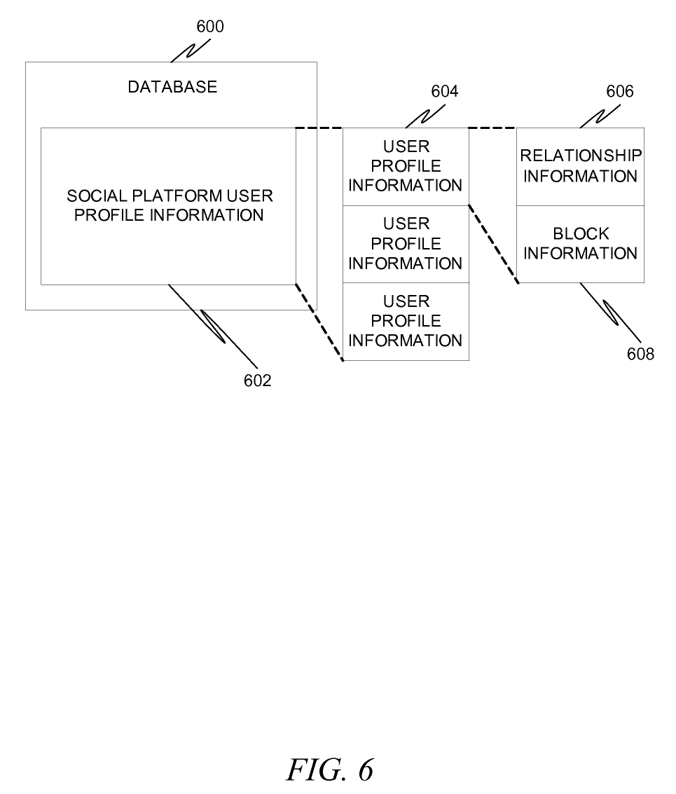

FIG. 6 is a block diagram illustrating a database 600, according to an example embodiment, at the social networking server. The database 600 is shown to include social platform user profile information 602 that stores user profile information 604 for each user on the social networking server. The user profile information 604 may include information related to the user and, specifically, may include relationship information 606 and block information 608. The relationship information 606 may store a predetermined relationship between the user associated with the user profile information 604 and other users on the social networking server. For example, a first user may be designated a “friend,” “favorite friend,” or the like, with a second user, with the first user associated with the user profile information 604 and the respective designations associated with increasing levels of disclosure between the first user and second user. The block information 608 may store a configured preference of the user to block the addition of an item by other users to a watch list associated with the user. In some instances, one or more components of the networked system 102 of FIG. 1 may be able to access specified portions of the database 600 via, for example, a programmatic interface. As such, data from the database may be mined.

In an example embodiment, content from social media is used to suggest products of interest to a user. In this example embodiment, the content utilized for such purposes includes express interests (such as “likes” from a Facebook™ profile) and demographic information (derived from, for example, a Facebook™ profile, such as gender and age group). In other embodiments, alternative or additional content may be utilized from social media, including posts, thumbs-up, friends, status updates, check-ins, etc.

In an example embodiment, each express interest from a social media profile is correlated to a social media category. In one example, the social media category may be defined by the social media services. For example, Facebook™ provides 214 categories. Then differences based on demographic information may be examined. For example, it may be learned that males are more likely to have an express interest in football while females are more likely to have an express interest in fashion. Following this, a correlation may be obtained between categories of purchases from an ecommerce service (such as eBay™) and the categories and demographic information from the social media service. Thus, each social media category may be correlated to one or more ecommerce categories (eBay™, for example, currently has about 35 different categories). A machine learning technique may then be used to provide a list of potential categories of interest for any particular social media profile. In this way, even in a cold-start environment, relevant potential purchases may be presented to a user, based on the user's social profile.

The use of a user's likes to derive social media categories which are then used to derive ecommerce categories and then obtain results allows for a very efficient and effective solution.

In an example, a dataset containing a random sample of tens of thousands of anonymized ecommerce users that connected to a social media site may be used. Users under 18 years of age and those who have no social media likes or have not made any purchases on ecommerce in 2012 were excluded. For each user, the dataset stores the following information:

(1) Basic demographic information obtained from social media, including age and gender;
(2) social media likes and their categories; and
(3) A list of items purchased on ecommerce from January to August 2012 (item name and category).
An example of user information from this dataset is shown in Table 1.

TABLE 1

| | |
|---|---|
| Name | Anonymous |
| Gender | Male |
| Age Group | 35-44 |
| Likes (social media category) | Beatles (Musician/band) |
| | iPhone 5 (Electronics) |
| | Starbucks (Food/Beverage) |
| | Walt Disney Studios (Movie) |
| Ecommerce Purchases (ecommerce | iPhone 4S (Electronics) |
| category) | Beatles T-shirt (clothing) |
| | Beatles Mug (Collectibles) |

Basic statistics of the dataset are reported in Table 2.

| | |
|---|---|
| Users | 13618 |
| Social Media categories | 214 |
| Social Media pages | 1,373,984 |
| Social Media likes | 4,165,690 |
| ecommerce categories | 35 |
| ecommerce purchases | 628,753 |

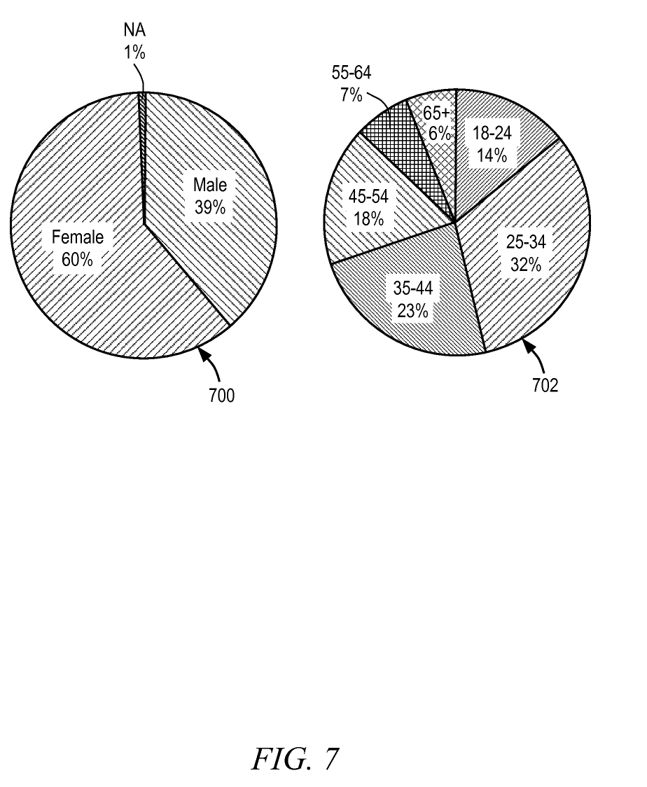

FIG. 7 reports a pie graph showing the distribution of gender and age in the dataset in accordance with an example embodiment. Notice a prevalence of women 700 (60% of all users) and people aged between 25 and 44 702 (55% of all users). Later it will be described how this information can be used to explore whether users in different demographic groups have distinctive purchase behaviors.

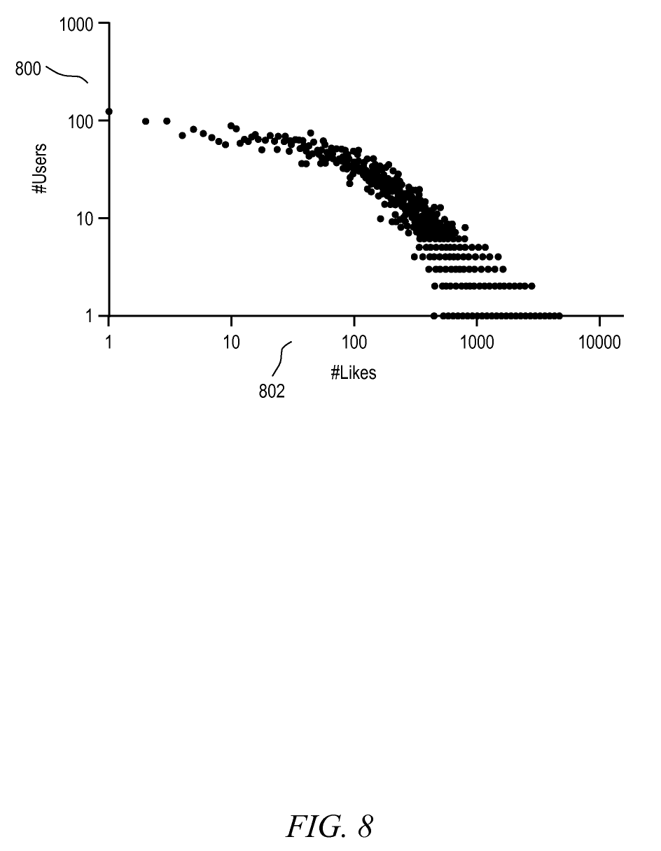

FIG. 8 reports a graph showing the distribution of Social Media likes for users in accordance with an example embodiment. This indicates how many users 800 have liked 802 a given number of pages. The function is approximately the power law with only a few outlier fluctuations, meaning that most users like few social media pages, and few users like many pages (median is 152 likes). While not surprising, this indicates that the task is inherently difficult: for most users the system will need to rely on scarce social media information for predicting their purchase behaviors.

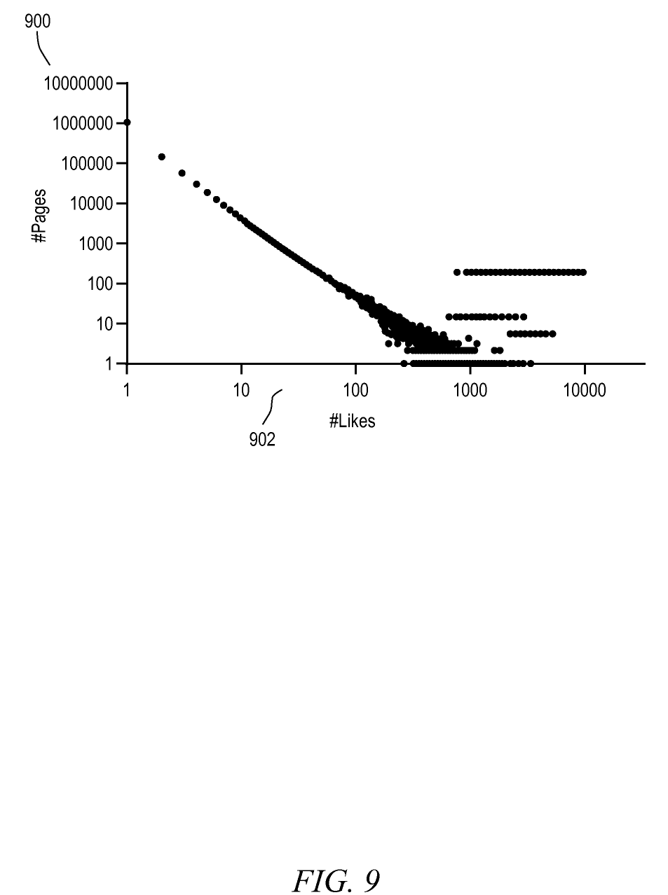

FIG. 9 reports a graph showing the distribution of likes for social media pages in accordance with an example embodiment. This indicates how many pages 900 have a given number of likes 902. The function follows a perfect power law, showing that the majority of social media pages have few likes and only a few pages receive many likes (median is 1 like). The fact that users' likes are so sparse poses a great challenge for the prediction task when likes are used as features.

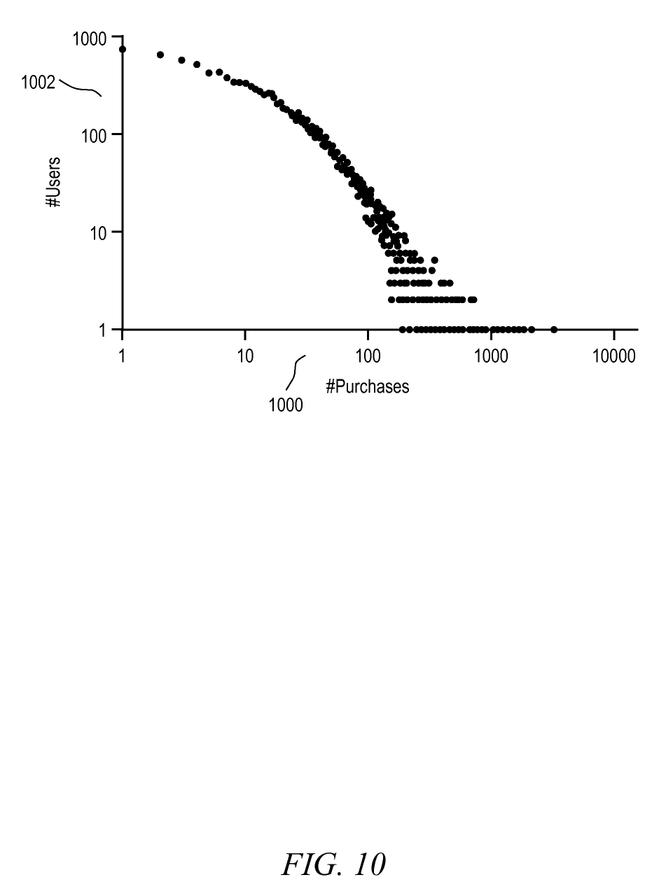

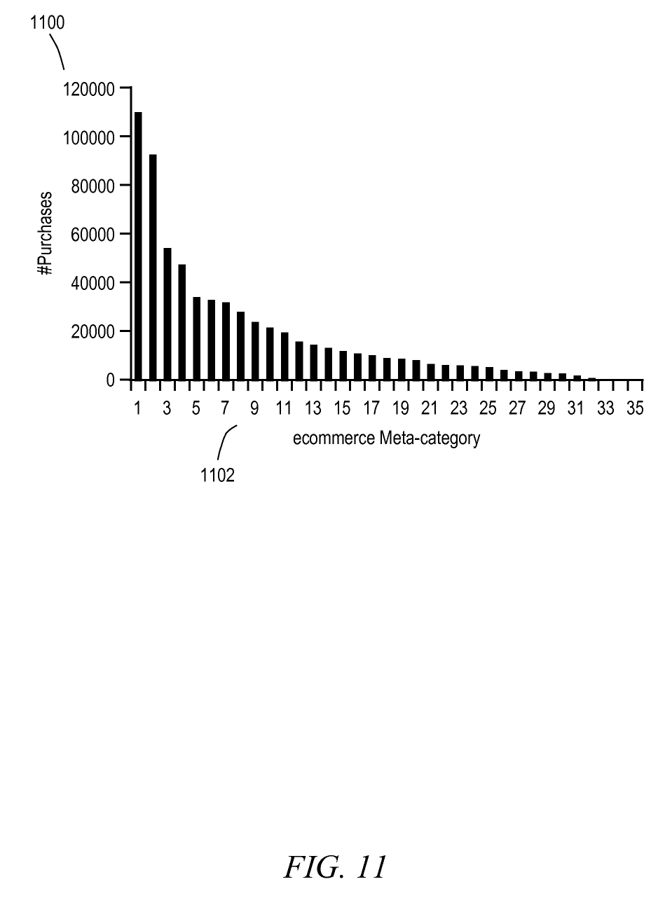

As regards to user behaviors in ecommerce transactions, the distribution of purchased items is also the power law, as shown in FIG. 10, which reports a graph showing the number of purchases 1000 relative to the number of users 1002 in accordance with an example embodiment. This indicates that most users tend to buy a limited number of items. FIG. 11 reports a graph showing the distribution of purchases 1100 by ecommerce category (also known as meta-category) 1102, in accordance with an example embodiment. The distribution is highly skewed: more than 50% of all purchases come from the top five meta-categories. The Clothing category alone accounts for 17.5% of all purchases. In the current context this means that a system that selects the most popular meta-categories as a prediction of where a user will buy, would achieve a good degree of accuracy. The median value of purchases per category is 8,316; the average is 17,964.

The first important question that the system addresses is: are users focused when they buy online? One extreme hypothesis is that a user is completely unfocused, i.e., she likes to buy randomly across categories. On the other end, it may be that the user has few well-defined favorite categories from which she likes to buy.

The former hypothesis depicts a chaotic world where it is impossible to predict user behaviors and provide recommendations. The present system assumes the latter.

To answer the above question, let P(u)ₖ represent the ranked probability with which a user u buys from her k-est favorite category. This rank is obtained by first estimating the probability P(u, e) of a user u buying in each category e, and by successively ranking the probabilities:

$$P ( u , e ) = \frac{purc ( u , c )}{purc ( u , E )}$$

where purc(u, e) is the number of purchases of u in category e, and E is the set of all ecommerce meta-categories (currently at, for example 35). For example, if a user buys 4 items from one category and 2 from another, the result is: P(u)₁=0:67 and P(u)₂=0:33.

To have an estimation of purchase focus the P(u)ₖ can be averaged across all users U. The probability distribution for the event of the average user buying in the top-k ranked category is thus obtained:

$${P ( U )}_{k} = \frac{1}{\vert U \vert} \cdot {\sum }_{u ∈ U} {P ( u )}_{k}$$

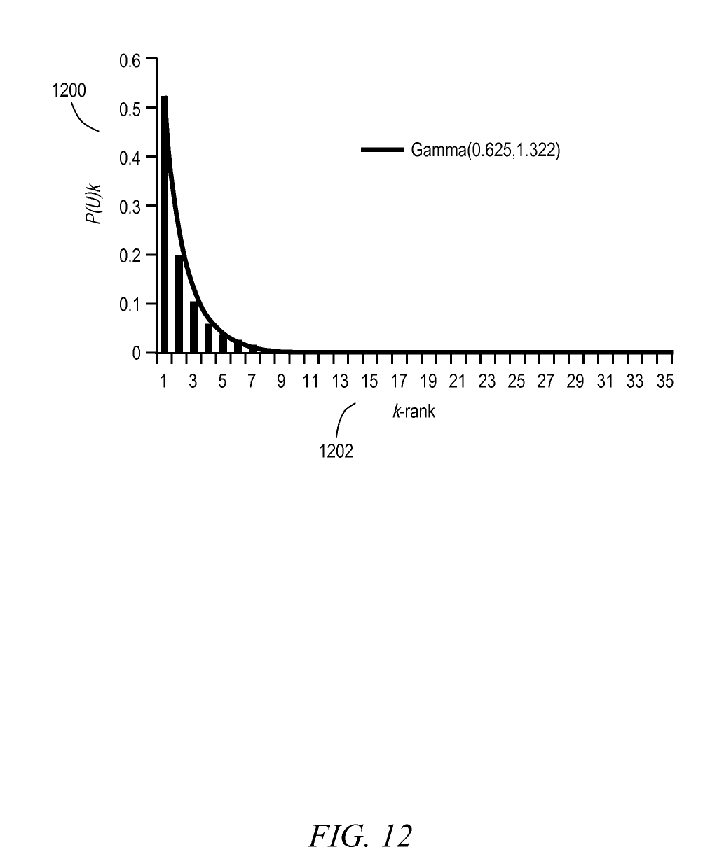

The probability mass function for the distribution is reported in FIG. 12, which depicts a graph showing the probability 1200 distribution by k-rank 1202. Thus, this depicts where categories are ordered by rank k.

The hypothesis of a chaotic world where a user buys randomly from different categories would be proved if the distribution was fitted by a uniform distribution. In an example embodiment, to check the fit, the Kolmogorov-Smirnov (K-S) goodness-of-fit test can be applied. The result of the test shows that the hypothesis is rejected. As expected, users do not buy randomly.

The K-S test can be repeated to check what continuous distribution best approximates the purchases distribution. The best fit is provided by a Gamma distribution (Γ(0:625; 1:322) with D-statistics 0:19).

The shape of the distribution indicates that users are very focused in their purchase behaviors. FIG. 12 shows that more than 50% of the time the average user buys from her preferred category and 20% of the time from the second preferred category. The top three categories collectively account for about 85% of a user's purchases.

Another important question is: do users express specific interests in social media, i.e., do they like specific categories of pages? Similarly to what was just performed for ecommerce categories, this question can be answered by checking the hypothesis that social media users like pages from random social media categories.

The probability distribution for the event of the average user liking a social media category f can be built using the same procedure used for e-commerce categories but replacing e with f. The mass function (not reported for space limitation) fits a Gamma distribution that is less steep than the Gamma approximating ecommerce categories. Again the chaotic world hypothesis can be rejected by running the K-S test on a uniform distribution. On average a social media user's favorite category accounts for 19% of all her liked pages, the second about 11%. Social media likes spread out to more categories with respect to ecommerce purchases, though users appear to be quite focused also on social media.

Overall, the results provided that users express strong personal interests in social media and are highly focused when purchasing on-line. One important question remains open. Is there a correlation between interests and purchases, i.e., do users purchase what they like on social media? If a correlation exists then social media likes can be used to predict what users will likely purchase.

The possible correlations between social media information and online purchases may now be explored. These can then be leveraged for building algorithms for predicting purchase behaviors. The focus may begin on demographic information available on social media, and later explore the use of the list of liked pages.

It can be analyzed whether women and men tend to buy from different ecommerce meta-categories. In order to do so, the percentage of users that buy in each category can be computed for each gender. For example about 70% of women in our dataset buy items from the Clothing, Shoes & Accessories category, while only 45% of men do.

For each category, a t-test may be carried out between women and men to verify if the difference in percentage is statistically significant. The results of the test show that women buy significantly more than men in 10 categories with a statistical significance of p=0:99. The most female-polarized categories are Jewelry & Watches, Crafts and Clothing, Shoes & Accessories. Men buy significantly more than women in 16 categories, the most polarized being Toys & Hobbies, Collectibles and Sports Memorabilia. For the remaining 9 ecommerce meta-categories we do not observe any significant difference.

These results show that purchase behavior strongly varies across genders. Differences across age groups are less strong. For example, in only 10 categories is there a significant difference between age groups 25-34 and 45-54. In general we observe that young people (25-34) tend to be prevalent in Fashion, while older people (45+) are prevalent in Collectibles and Books.

The overall demographic study suggests that gender and age are important signals for predicting the purchase behaviors of social-media users.

For the sake of completeness we also study gender and age differences in social media. Similarly to purchase behaviors, we note that different demographic segments tend to like different types of pages. Females are prevalent in liking Clothing and Health & Beauty pages, while males prevail in Electronics and Sports. Young users like more Actors & Directors while older people are prevalent in liking Politicians.

It is worth noting that these results refer to the dataset of 13,000 social media-connected ecommerce users, and may not generalize to the general population of social media users or to the whole ecommerce spectrum.

The system may study the correlation between ecommerce meta-categories and social media categories, and check if there are social media categories that are highly predictive of ecommerce meta-categories. For example one would expect that users that like many Fashion pages are likely to buy items in the Clothing, Shoes & Accessories ecommerce meta-category.

Two categorical variables F and E can be defined. F is defined on the sample space of users, and associates each user to the set of social media categories that she liked at least once. E associates each user to the ecommerce meta-categories that she has bought from at least once.

The correlation between social media and ecommerce categories can be determined by applying the Pearson's chi-square test on E and F. The chi-square test checks if the null-hypothesis that two random variables are independent (i.e. not correlated) is true or not. The result is a strong rejection of the null hypothesis with confidence p=0:95.

This result is encouragingly suggesting that the set of social media categories may be predictive of purchase behaviors. However, the test is generic and does not directly indicate which specific social media category f is highly correlated to which ecommerce meta-category e.

The Pearson's chi-square test can be computed on single (e, f) events (e.g., tested on a 2×2 contingency table).

Table 3 reports the obtained correlations for some ecommerce meta-categories. For all the pairs reported in the table the null hypothesis that they are independent is rejected with confidence p=0:99.

TABLE 3

| eCommerce category | Social media category | X |
|---|---|---|
| Computers/Tablets | Computers/Technology | 52.0 |
| Computers/Tablets | Software | 51.9 |
| Music | Record Label | 95.5 |
| Music | Musical Instrument | 67.1 |
| Travel | Bags/luggage | 7.9 |
| Travel | Book Genre | 5.9 |
| Jewelry & Watches | Jewelry/watches | 63.6 |
| Jewelry & Watches | Health/beauty | 13.4 |
| Cell Phones & Accessories | Telecommunications | 67.2 |
| Cell Phones & Accessories | Electronics | 46.1 |

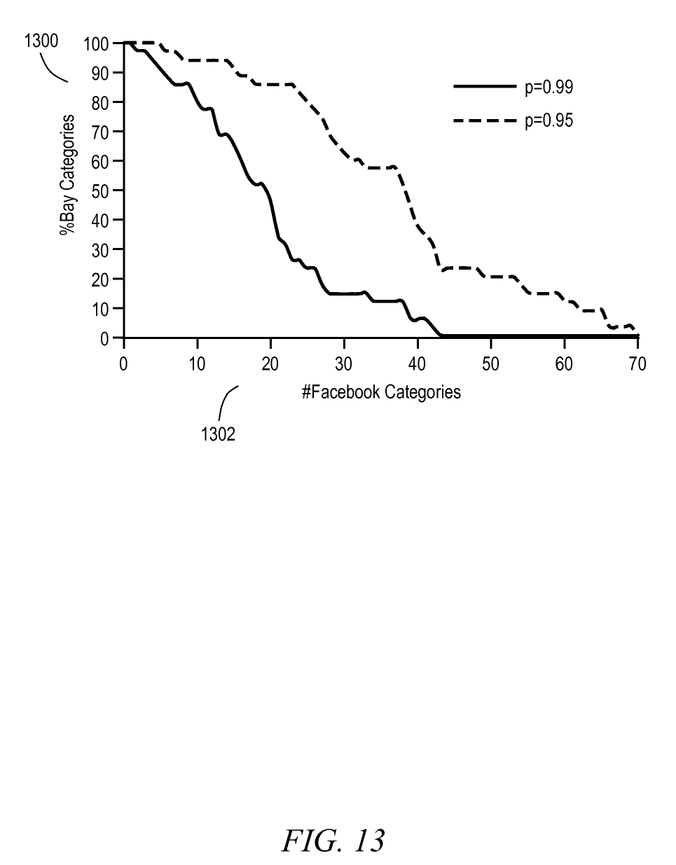

FIG. 13 depicts a graph showing the percentage of ecommerce categories (y-axis) 1300 that have a given number of highly correlated (either p=0:99 or p=0:95) social media categories (x-axis) 1302, in accordance with an example embodiment. As the figure shows, all ecommerce categories have at least one highly associated social media category, while only 15% of ecommerce categories have 30 or more correlated social media categories at p=0:99. The median number of correlated social media categories across all ecommerce categories at the p=0:99 level is 19. The median number of correlated social media categories at the p=0:95 level is 35.

These results are very promising. The large number of discovered correlations suggests that ecommerce categories may be easily predicted by looking at the social media categories liked by the user. However, some ecommerce categories are inherently hard to predict. For example, Real Estate, Art and Everything else have respectively only 4, 5 and 6 correlated social media categories. This may not be sufficient to correctly support a predictive algorithm for those specific ecommerce meta-categories.

The reason for such low correlations is twofold. First, some ecommerce categories correspond to concepts that are not popularly liked in social media (e.g., not many people like Real Estate companies). Second, some categories are too broad and vague to establish correlations (e.g., Everything else and Art).

As described above, the dataset used may comprise 13,619 ecommerce users who connected to social. For each user u the system may rank categories by assigning to each category e the ranking score:

$$gsRank ( u , {e}_{i} ) = \frac{\vert purch ( u , {e}_{i} ) \vert}{{sum}_{e ∈ E} \vert purc ( u , e ) \vert}$$

establishing the rank:

eᵢ [symbol] eⱼ [symbol] gsRank(u,eᵢ)>gsRank(u,eⱼ)

Categories with the same ranking score are considered ties. For example if a user buys 5 items in Music, 3 in Crafts and 0 in Electronics, the ranking for the user will be: Music->Crafts->Electronics.

The ideal prediction algorithm should provide in output for each user a category ranking equivalent to the system.

To evaluate the prediction models the following measures may be used:

### (1) Normalized Discounted Cumulative Gain (NDCG).

For each user Discounted Cumulative Gain (DCG) is defined at position k as:

$${DCG}_{k} = {\sum }_{i = 1}^{k} \frac{w ( i )}{log ( i + 1 )}$$

where w(i) is relevance weight of the category ranked in position i (eᵢ) by the algorithm. The relevance weight is set as follows:

$$w ( i ) = \frac{purc ( ei )}{{\sum }_{e ∈ E} purc ( e )}$$

where purc(e) is the number of items bought by the user in category e. IDCG (ideal DCG) is defined at position k as the DCG of the algorithm at k. NDCG at position k is defined as:

$$\frac{{DCG}_{k}^{∼}}{{IDCG}_{k}} .$$

### (2) Precision at Rank k (Pₖ).

Given a position k in the predicted ranking for a given user, Pᵣ is defined as:

$${P}_{r} = \frac{{\sum }_{i = 1}^{k} B ( {e}_{i} )}{k}$$

where B(eᵢ) equals 1 if the user bought at least one item from category eᵢ and zero otherwise. Pₖ is computed for each position, until the position at which the algorithm has retrieved all categories with B(eᵢ)=1 is reached.

Note that the system does not use any ranking correlation coefficient for the evaluation (e.g. Spearman or Kendall Tau). Given that it is solving a ranking problem, this choice may seem counterintuitive. However, in this case it is not interested in computing how similar two rankings are as a whole, but just how good an algorithm is in catching the correct categories as early as possible. In this case, NDCG and precision at rank are more reliable measures.

The ranking models are evaluated using 10-fold cross validation in order to reliably compute statistical significance values. For each fold 90% of the users are used as training and 10% as testing. The above measures are computed for each fold by averaging the measures over all testing users.

Baseline.

A reasonable system that ranks categories according to their popularity, i.e. the number of users in the training set who have bought from the category.

Supervised Mapping.

A simple supervised model could also be used. In the training phase, a bipartite graph can be built where the left side nodes are social media categories and the right side nodes are ecommerce meta-categories. An edge can be drawn between a social media category f and an ecommerce meta-category e if there exists at least one user who likes a page in f and have bought an item in e. The weight of the edge is computed as:

w(f,e)=|f,e|

where |f, e| is the number of users who like at least one page in f and have bought from e. In testing phase, for each user u and ecommerce meta-category e the ranking score may be computed:

Σ_{fεF}_{ᵤ}w(f, e) where Fᵤ is the set of social media categories that user u likes at least once. The ranking score is used to produce the output ranking for each user.

Naive Bayes (NB) Classification.

A standard Naive Bayes model can be used, which for each user-category pair predicts the probability that the user will purchase from the category. The algorithm returns the ranked list of categories for each user.

Logistic Regression (LR).

LinLinear can be used to build a regression model for each ecommerce meta-category e, for a total of 35 models. For training, a user u is represented by a feature vector, and the label is the ranking score gsRank(u, e). During testing, for each user the predicted gsRank scores for each category are gathered as produced by the 35 models, and the categories are ranked accordingly. The L2 regularization parameter is optimized on a subset of the training set.

Support Vector Machines (SVM) Classification.

SVMlight can be used to build a SVM classification model for each ecommerce meta-category e. For training, positive examples are users that buy at least one item in e. An equal number of random negative examples is provided. During testing, for each unknown user SVM returns a confidence score that are used for ranking SVM parameters are chosen by grid search on a subset of the training sets. Results are reported for a Radial Basic Function (RBF) kernel. Results for the linear kernel are comparable or below RBF.

All the machine learning algorithms (Naive Bayes, Logistic Regression, and SVM classification) may be reported using various feature families. Features can be grouped in the following four families:

1) Demographics (D). Earlier, it was shown that different gender and age groups tend to buy in specific ecommerce categories. It is therefore natural to use demographic information as features for the learning algorithms.

A total of eight binary features are used to represent each gender (male or female) and age group (18-24, 25-34, 35-44, 45-54, 55-64, 65+), where the feature value is 1 if the user is of a given gender/age group, 0 otherwise.

2) Social Media Categories (F). This feature family includes 214 features, one for each social media category in the dataset. For each user u and social media category f the feature value is computed using tf−idf as follows:

$$tfidf ( u , f ) = \frac{like ( u , f )}{{max}_{{f}_{i} ∈ F} like ( u , {f}_{i} )} \cdot log \frac{\vert U \vert}{\vert ( U , f ) \vert}$$

where like(u, f) is the number of page likes by user u in category f, and |(U, f)| is the number of users who like at least one page in category f.

3) Social media Likes (L). In addition to social media categories, one could also experiment with features derived directly from the liked pages. The intuition is that category features may be too generic to capture useful correlations with the ecommerce categories that need to be predicted; or even worse, there may be no social media categories predictive of an ecommerce category. In such cases, page-level features may help.

The values of these features is computed similarly to social media categories, i.e. by computing the tf−idf between users and likes.

This feature family includes all the 1.3 million pages liked by users in our dataset. Since the number of irrelevant features may be high, we perform feature selection before feeding the feature vectors to the machine learning algorithms. The feature selection strategy we use is Information Gain (IG), since it has proved to be effective in many learning tasks, e.g. text categorization. Information Gain computes the number of bits of information obtained for the prediction task from a new feature. The information gain of a like l is formally defined as follows:

$$IG ( l ) = - {\sum }_{i = 1}^{\vert E \vert} P ( {e}_{i} ) log P ( {e}_{i} ) + P ( l ) {\sum }_{i = 1}^{l} P ( {e}_{i} \vert l ) log P ( {e}_{i} \vert l ) + P ( \overline{l} ) {\sum }_{i = 1}^{\vert E \vert} P ( {e}_{i} \vert \overline{l} ) log P ( {e}_{i} \vert \overline{l} ) .$$

where |E| is the number of ecommerce categories; P(eᵢ) is approximated by the fraction of training users that buy category eᵢ; P(l) by the fraction of users that like l; P(eᵢ|l) is approximated by the fraction of users liking l that also buy in category eᵢ; and P( l̅) is approximated by the fraction of users that do not like l.

For each unique like in the dataset, its information gain can be computed and all likes whose information gain is less than a predefined threshold (5% of maximum IG) can be removed. The underlying reasoning is that likes with high information gain are more useful for category prediction. Hence, the quality of a like feature is proportional to its information gain score, i.e., the higher the G(l) score, the better the feature is. Using the ecommerce category Clothing, Shoes & Accessories as an example, the top 10 social media likes ranked by IG are: Sephora, Victoria's Secret, Victoria's Secret Pink, Bath & Body Works, JustFab, Macy's, Coach, ShoeDazzle, Fashion, MAC Cosmetics. As can be seen, the top likes are highly related to the Clothing, Shoes & Accessories category.

4) Social media n-grams (N). One can also experiment with n-grams (n=1,2,3) derived from individual social media page names, e.g. for the social media page Boston Running Club we will create a set of candidate n-grams: {boston, running, club, boston running, running club, boston running club}. Since there are 1.3 million social media pages, the number of derived n-grams will be even bigger. Feature selection can then also be performed in this case, to choose the most informative unigrams, bigrams and trigrams. Each user is represented using a feature vector of tf−idf values of top n-grams.

Table 4 reports the results of different algorithms using the complete set of features (demographics, social media categories, likes and n-grams) with feature selection.

TABLE 4

| Algorithm | P₁ | P₂ | P₃ | P₄ | P₅ | NDCG₁ | NDCG₂ | NDCG₃ | NDCG₄ | NDCG₅ |
|---|---|---|---|---|---|---|---|---|---|---|
| Baseline | 0.668 | 0.547 | 0.513 | 0.454 | 0.451 | 0.668 | 0.694 | 0.709 | 0.701 | 0.680 |
| Mapping | 0.668 | 0.571 | 0524 | 0.494 | 0.489 | 0.643 | 0.690 | 0.701 | 0.698 | 0.688 |
| NB | 0.643 | 0.560 | 0.502 | 0.477 | 0.469 | 0.643 | 0.690 | 0.701 | 0.698 | 0.688 |
| LR | 0.733 | 0.655 | 0.628 | 0.582 | 0.565 | 0.733 | 0.784 | 0.785 | 0.770 | 0.759 |
| SVM | 0.725 | 0.653 | 0622 | 0.570 | .0530 | 0.725 | 0.780 | 0.782 | 0.768 | 0.752 |

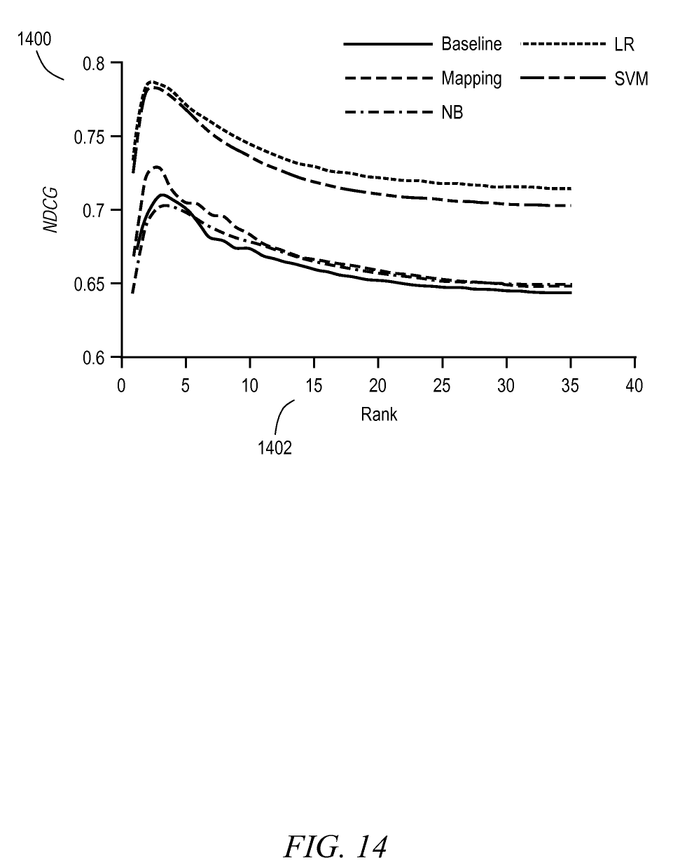

FIG. 14 is a graph depicting the trend of NDCG 1400 at different rank levels 1402, for all the experimented algorithms, in accordance with an example embodiment.

Logistic Regression and SVM significantly outperform the baseline system at all rank levels in both precision and NDCG. The Mapping system and Naive Bayes show significantly lower accuracy.

In general the Baseline system has good performance. Predicting meta-categories by simply ranking popularity proves to be a hard baseline to beat, as one would have expected from the statistics reported in FIG. 14.

The Mapping algorithm performs slightly better than Baseline, but without statistical significance. Overall, the performances of the two algorithms are very similar. In order to better understand the reason for this behavior, the similarity of the ranking produced by the two algorithms can be measured.

This can be performed by computing the Jaccard similarity coefficient J on the set of top 7 ranked categories. J=0:74 is obtained, i.e. on average Baseline and Mapping share 5 out of the top 7 predicted categories. The reason for this high correlation is that the weight in the equation promotes ecommerce categories that are very popular among users, similar to what Baseline does.

Naive Bayes is the worst performing algorithm, showing performance below or very close to the baseline. A possible explanation is that Naive Bayes assumes feature independence, while the features derived from social media profiles are not necessarily independent of one another. For example, the category Sports and Sport Teams are highly dependent on each other. The Jaccard coefficient between Naive Bayes and Baseline is J=0:52, showing that the Naive Bayes system is mildly correlated to Baseline, but not as much as Mapping.

The top performing systems, Logistic Regression and SVM, are far apart from all others. The good performance of SVM is expected. A large volume of previous work has already shown its superior classification power with respect to Naïve Bayes and other basic approaches. As for the good performance of Logistic Regression, it indicates that using a regression approach to purchase prediction is a viable, promising direction.

Overall, the results suggest that SVM and Logistic Regression make much better use of the social features than Mapping and Naive Bayes. These two latter systems appear to be more influenced by the strong meta-category prior probabilities than by the features themselves.

Table 5 summarizes experimental results for the different feature families. All feature families taken in isolation outperform the baseline (row 2-5 of FIG. 4) Demographic features (D) show the smallest improvement. However, results still indicate that simple demographic information easily available on social media, such as age and gender, can help significantly in the purchase prediction task. This is particularly important for those ecommerce applications that do not request the social media user to share the complete list of likes.

TABLE 5

| Feature | | | | | | | | | | |
|---|---|---|---|---|---|---|---|---|---|---|
| Sets | P₁ | P₂ | P₃ | P₄ | P₅ | NDCG₁ | NDCG₂ | NDCG₃ | NDCG₄ | NDCG₅ |
| Baseline | 0.668 | 0.547 | 0.513 | 0.454 | 0.451 | 0.668 | 0.694 | 0.709 | 0.701 | 0.680 |
| D | 0.670 | 0.593 | 0.565 | 0.534 | 0.504 | 0.670 | 0.728 | 0.735 | 0.721 | 0.710 |
| F | 0.708 | 0.652 | 0.621 | 0.572 | 0.549 | 0.708 | 0.761 | 0.765 | 0.749 | 0.736 |
| L | 0.706 | 0.647 | 0.613 | 0.568 | 0.538 | 0.706 | 0.759 | 0.761 | 0.748 | 0.733 |
| N | 0.705 | 0.636 | 0.605 | 0.563 | 0.533 | 0.705 | 0.757 | 0.760 | 0.745 | 0.732 |
| F + D | 0.715 | 0.649 | 0.623 | 0.575 | 0.553 | 0.715 | 0.766 | 0.770 | 0.765 | 0.753 |
| F + L | 0.718 | 0.657 | 0.625 | 0.576 | 0.555 | 0.718 | 0.770 | 0.775 | 0.768 | 0.755 |
| F + N | 0.717 | 0.655 | 0.623 | 0.578 | 0.552 | 0.717 | 0.769 | 0.776 | 0.766 | 0.752 |
| F + D + L | 0.723 | 0.653 | 0.634 | 0.586 | 0.559 | 0.723 | 0.775 | 0.782 | 0.771 | 0.756 |
| F + D + N | 0.722 | 0.657 | 0.624 | 0.577 | 0.558 | 0.721 | 0.773 | 0.780 | 0.770 | 0.758 |
| F + L + N | 0.729 | 0.656 | 0.629 | 0.581 | 0.563 | 0.729 | 0.780 | 0.778 | 0.763 | 0.750 |
| F + D + L + N | 0.733 | 0.655 | 0.628 | 0.582 | 0.565 | 0.733 | 0.784 | 0.785 | 0.770 | 0.759 |

All other individual feature families, i.e. social media categories (F), likes (L) and n-grams (N), significantly outperform D features. This is not surprising because these feature families provide much richer and more relevant information with respect to age and gender. Intuitively, it may often be the case that D features are subsumed by F, L and N. As a matter of fact, as shown earlier, the social media categories preferred by a user are usually correlated to her gender.

Within the four individual feature families, F performs best, indicating that social media profiles at the category level convey enough information for predicting users' purchase behaviors on ecommerce sites. However the small difference in performance of F with respect to N and L also suggests that F, N and L mostly convey the same information.

From the one side this is an expected result, since all these three feature families are generated from the same source (the list of users' likes). From the other side, one would have expected L and N to slightly outperform F, since they carry more ingrained information. A closer analysis of the L and N feature sets reveals that these features are often too sparse, thus limiting their prediction power. On the contrary, F features are general enough to provide generalization power across users.

When the best individual feature family F is combined with other feature families in different combinations (rows 6-12), there can be seen a small additional gain in prediction quality.

For example, when social media categories and likes are combined, P₁ goes up from 0.708 for F and 0.706 for L to 0.718. In general, the more feature families used, the greater the gain in prediction quality. However, the gain in performance is very small. As already outlined in the previous paragraph, N and L come from the same source of F and have sparsity problems; therefore, they do not carry new relevant information with respect to F. More surprisingly, we would have expected the performance of F to be increased when in combination with D. On the contrary the F+D combination results in a small decrease in performance.

It is finally worth mentioning that the dimensional space of social media likes and n-grams is much larger than that of social media categories. Hence, when computational cost is a concern, social media categories may be more favorable in some embodiments.

Feature Selection.

All results reported so far use Information Gain for selecting top likes and n-grams. To check the effect of feature selection, Naive Bayes and Logistic Regression may be run on the whole set of features but without any feature selection. Results show that both Naive Bayes and Logistic Regression perform worse when feature selection is not performed. For example, P1 for Naive Bayes goes from 0.643 with feature selection to 0.376 without feature selection and P2 goes from 0.560 to 0.392.

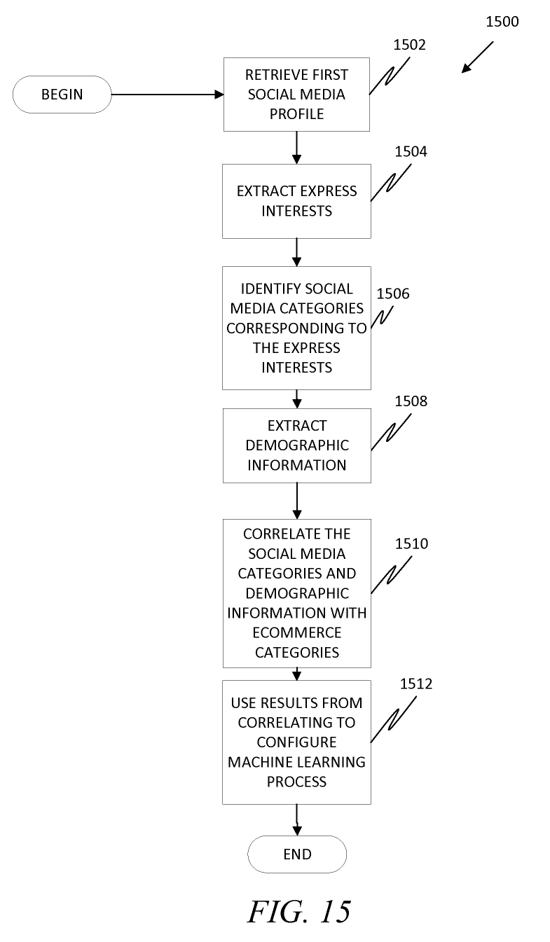

FIG. 15 is a flow diagram illustrating a method 1500 in accordance with an example embodiment. At operation 1502, a first social media profile is retrieved. This may be retrieved from, for example, a schema from a social media service. At operation 1504, express interests may be extracted from the first social media profile. At operation 1506, social media categories corresponding to the express interests may be identified. At operation 1508, demographic information may be extracted from the first social media profile. At operation 1510, the identified social media categories and demographic information may be correlated with ecommerce categories of purchases. The ecommerce categories may be retrieved from, for example, a schema of an ecommerce service. At operation 1512, the results from the correlating may be used to configure a machine learning process, the machine learning process accepting a second social media profile as input and returning a prediction of an ecommerce category as output.

### Example Mobile Device

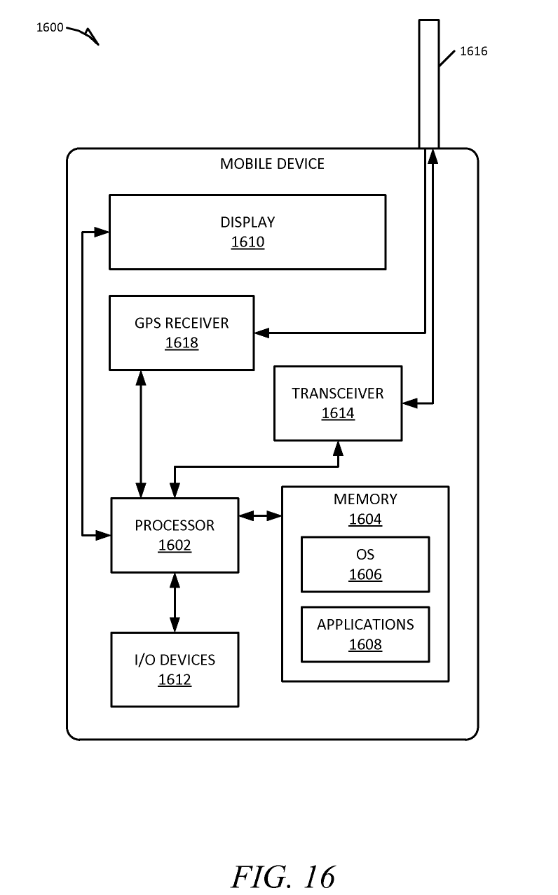

FIG. 16 is a block diagram illustrating a mobile device 1600, according to an example embodiment. The mobile device 1600 may include a processor 1602. The processor 1602 may be any of a variety of different types of commercially available processors suitable for mobile devices (for example, an XScale architecture microprocessor, a microprocessor without interlocked pipeline stages (MIPS) architecture processor, or another type of processor 1602). A memory 1604, such as a random access memory (RAM), a flash memory, or other type of memory, is typically accessible to the processor 1602. The memory 1604 may be adapted to store an operating system (OS) 1606, as well as application programs 1608, such as a mobile location enabled application that may provide LBSs to a user. The processor 1602 may be coupled, either directly or via appropriate intermediary hardware, to a display 1610 and to one or more input/output (I/O) devices 1612, such as a keypad, a touch panel sensor, a microphone, and the like. Similarly, in some embodiments, the processor 1602 may be coupled to a transceiver 1614 that interfaces with an antenna 1616. The transceiver 1614 may be configured to both transmit and receive cellular network signals, wireless data signals, or other types of signals via the antenna 1616, depending on the nature of the mobile device 1600. Further, in some configurations, a GPS receiver 1618 may also make use of the antenna 1616 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors 1602 may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure processor 1602, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors 1602 that are temporarily configured (e.g., by software) or permanently configured to perform the relevant operations. Whether temporarily or permanently configured, such processors 1602 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 1602 or processor-implemented modules. The performance of certain of the operations may be distributed among the one or more processors 1602, not only residing within a single machine, but deployed across a number of machines. In some example embodiments, the processor 1602 or processors 1602 may be located in a single location (e.g., within a home environment, an office environment or as a server farm), while in other embodiments the processors 1602 may be distributed across a number of locations.

The one or more processors 1602 may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 1602, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors 1602 executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 1602), or a combination of permanently and temporarily configured hardware may be a design choice. Below are set out hardware (e.g., machine) and software architectures that may be deployed, in various example embodiments.

### Example Machine Architecture and Machine-Readable Medium

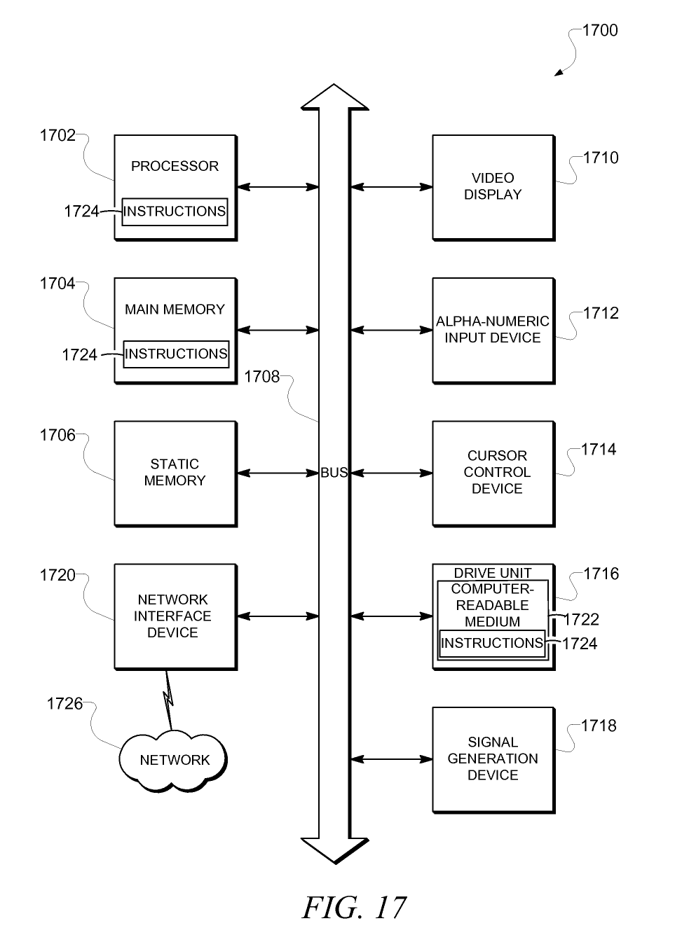

FIG. 17 is a block diagram of machine in the example form of a computer system 1700 within which instructions 1724 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes a processor 1702 (e.g., a central processing unit (CPU), a graphics processing unit (GPU) or both), a main memory 1704 and a static memory 1706, which communicate with each other via a bus 1708. The computer system 1700 may further include a video display unit 1710 (e.g., a liquid crystal display (LCD) or a cathode ray tube (CRT)). The computer system 1700 also includes an alphanumeric input device 1712 (e.g., a keyboard or a touch-sensitive display screen), a user interface (UI) navigation (e.g., cursor control) device 1714 (e.g., a mouse), a disk drive unit 1716, a signal generation device 1718 (e.g., a speaker) and a network interface device 1720.

### Machine-Readable Medium

The disk drive unit 1716 includes a computer-readable medium 1722 on which is stored one or more sets of data structures and instructions 1724 (e.g., software) embodying or utilized by any one or more of the methodologies or functions described herein. The instructions 1724 may also reside, completely or at least partially, within the main memory 1704 and/or within the processor 1702 during execution thereof by the computer system 1700, the main memory 1704 and the processor 1702 also constituting computer-readable media 1722.

While the computer-readable medium 1722 is shown in an example embodiment to be a single medium, the term “computer-readable medium” may include a single medium or multiple media (e.g., a centralized or distributed database, and/or associated caches and servers) that store the one or more instructions 1724 or data structures. The term “computer-readable medium” shall also be taken to include any tangible medium that is capable of storing, encoding or carrying instructions 1724 for execution by the machine and that cause the machine to perform any one or more of the methodologies of the present disclosure or that is capable of storing, encoding or carrying data structures utilized by or associated with such instructions 1724. The term “computer-readable medium” shall accordingly be taken to include, but not be limited to, solid-state memories, and optical and magnetic media. Specific examples of computer-readable media 1722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 1724 for execution by the machine, and includes digital or analog communications signals or other intangible media to facilitate communication of such software.

Although the inventive subject matter has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. An apparatus comprising:
a processor; and
a memory,
the processor configured to:
retrieve a first social media profile;
extract express interests in the first social media profile;
identify social media categories corresponding to the express interests;
extract demographic information from the first social media profile;
correlate the identified social media categories and demographic information with ecommerce categories of purchases; and
use results from the correlating to configure a machine learning process, the machine learning process accepting a second social media profile as input and returning a prediction of an ecommerce category as output.

2. The apparatus of claim 1, wherein the first social media profile is retrieved from a social media service.

3. The apparatus of claim 2, wherein the social media categories are identified using a schema provided by the social media service.

4. The apparatus of claim 3, wherein the correlating includes obtaining a schema of ecommerce categories of purchases from an ecommerce service.

5. The apparatus of claim 1, wherein the demographic information includes gender information.

6. The apparatus of claim 1, wherein the demographic information includes age information.

7. A method comprising:
retrieving a first social media profile;
extracting express interests in the first social media profile;
identifying social media categories corresponding to the express interests;
extracting demographic information from the first social media profile;
correlating the identified social media categories and demographic information with ecommerce categories of purchases; and
using results from the correlating to configure a machine learning process, the machine learning process accepting a second social media profile as input and returning a prediction of an ecommerce category as output.

8. The method of claim 7, further comprising:
using the machine learning process to recommend one or more items for sale to a user corresponding to the second social media profile in the ecommerce category predicted using the second social media profile.

9. The method of claim 8, wherein the machine learning process also accepts social media communications as input.

10. The method of claim 9, wherein the social media communications include posts.

11. The method of claim 9, wherein the social media communications include friends.

12. The method of claim 9, wherein the social media communications include recommendations.

13. The method of claim 9, wherein the social media communications include check-ins.

14. A non-transitory machine-readable storage medium having embodied thereon instructions executable by one or more machines to perform operations comprising:
retrieving a first social media profile;
extracting express interests in the first social media profile;
identifying social media categories corresponding to the express interests;
extracting demographic information from the first social media profile;
correlating the identified social media categories and demographic information with ecommerce categories of purchases; and
using results from the correlating to configure a machine learning process, the machine learning process accepting a second social media profile as input and returning a prediction of an ecommerce category as output.

15. The non-transitory machine-readable storage medium of claim 14, further comprising:
using the machine learning process to recommend one or more items for sale to a user corresponding to the second social media profile in the ecommerce category predicted using the second social media profile.

16. The non-transitory machine-readable storage medium of claim 15, wherein the machine learning process also accepts social media communications as input.

17. The non-transitory machine-readable storage medium of claim 16, wherein the social media communications include posts.

18. The non-transitory machine-readable storage medium of claim 16, wherein the social media communications include friends.

19. The non-transitory machine-readable storage medium of claim 16, wherein the social media communications include recommendations.

20. The non-transitory machine-readable storage medium of claim 16, wherein the social media communications include check-ins.
